(19) United States
(12) Patent Application Publication
(10) Pub. No.: US 2003/0221110 A1
(43) Pub. Date: Nov. 27, 2003

(54) Method of disposable command encoding (DCE) for security and anonymity protection in information system operations

(76) Inventors: Anton Kryvoruchko, Zaporozhye (UA); Viktor Syvodid, Zaporozhye (UA)

Correspondence Address: DECKER, JONES, MCMACKIN, MCCLANE, HALL &, BATES, P.C., BURNETT PLAZA 2000, 801 CHERRY STREET, UNIT #46, FORT WORTH, TX, 76102-6836, US

(21) Appl. No.: 10/441,989

(22) Filed: May 20, 2003

Related U.S. Application Data
(60) Provisional application No. 60/382,890, filed on May 23, 2002.

(51) Int. Cl. H04L 9/00

(52) U.S. Cl. 713/183; 713/202; 705/74

(57) ABSTRACT

A method for secure user access to the information system through any open communications network consists in encoding of system-allowed user's directives by the disposable command passwords. Then the user obtains the authority to run the commands in the information system once only by means of receipt or purchase of their respective disposable command passwords. The open communications network includes the Internet, telephone lines, wireless, etc. The method offers both hardware and software independence. User can carry out the electronic transactions and control their status in real-time from anywhere without any additional software installation. A system based on the method of disposable command encoding can be applied to electronic payment processing, online banking, money transfers. For disposable password distribution the system uses special password-carrying medium named netnote that the user purchases at a point of sale agent. The netnotes can be used to purchase a wide range of goods or services at any vendor involved in the electronic commerce.

### CROSS-REFERENCE TO RELATED APPLICATION

This application is a continuation-in-part of U.S. provisional patent application Serial No. 60/382,890, filed on May 23, 2002, entitled “Disposable influence encoding as a means of security and anonymity protection in information system operations”, which is incorporated herein by reference in its entirely.

### BACKGROUND OF THE INVENTION

This invention relates to security protection in the information systems. The invented method provides the information system's users with safe and anonymous access to its resources regardless of communications network type and hardware. Also, this method is particularly useful in electronic transactions, including electronic payment processing systems.

Everyday people identify and process a tremendous amount of information or data. It is relatively easier to secure data stored on a hard drive of your personal computer, or in any computer for that matter, but when sensitive data is transmitted by telephone or the Internet, the risk of interception and theft rises dramatically. Data theft due to hacked security is a common and costly problem today.

No existing data encryption algorithm is 100% hack-proof or can guarantee strict confidentiality of data because of quite simple mathematical logic. With a finite set of possible “keys” or “passwords” hacking becomes only a technical challenge to try all possible combinations until the right one is discovered. The password can also be compromised by human error, such as allowing it to be discovered and copied, or being scammed to divulge it.

Any nowadays encrypting system is grounded on two following basic presumptions: first, there is no quite effective algorithm for password or secret key decryption or fitting; and second, even if there is the one, its use is absurd because a desirable result of data deciphering can not be obtained within a reasonable amount of time. Regarding the first assumption, it is not theoretically proved that sufficiently effective password breaking algorithm does not exist and that, for example, the RSA asymmetric encryption with a pair of open public and secret private keys is impossible to break down. It is also true for the other encryption methods. As to the second assumption, considering a progress in microchip development and their consistent price reduction the more and more powerful hardware becomes available to the computer security violators or hackers. This means that a criminal can get equipped with computing power which is sufficient to decrypt secret data for much shorter periods than it was primarily supposed by the encrypting system makers. More productive and affordable computer's processing units make security experts create the longer keys that afterwards turn out insufficient again. Under these circumstances, in order to maintain an acceptable security level a key length increase seems interminable.

Another vulnerable part of electronic transactions in terms of security is a user's personal computer or terminal. For example, to intercept the information from the keyboard inputs it only takes a keyboard scanner program. At this juncture all allegedly secret data enters the network non-encrypted by the standard computer's keyboard that is the same worldwide. The scanner captures information from the key entries and forwards it to the hacker by an online collection. Such a program is not limited to password interception. It can also collect confidential data such as addresses, bank account or social security numbers, and pass it on to hacker automatically through the e-mail or by other means. Manifold viruses, worms or the similar programs are employed to implant a keyboard scanner into the user's computer operating system. Alternatively, a hacker can gain access to install harmful software remotely by several other means involving human error or a criminal deal.

Installation of a firewall program protects only the operating system of computer and is powerless against the browser's security flaws. The firewall does not prohibit browser to receive the potentially dangerous data formats and file extensions from the Internet. Otherwise, it would be impossible for the Hypertext Mark-up Language (HTML)-pages content to be viewed.

As well, secret data may be compromised by hacking the peripheral devices such as the Point-of-Sale (POS) terminals and Automatic Teller Machines (ATM). For this purpose the hacker may use different types of equipment for illegal data reading and/or recording.

The user who follows all security recommendations issued by the manufactures of the PC operating systems and application software is still subjected to massive attack from the World Wide Web. The cyber criminals might try to obtain his or her personal data by creation of miscellaneous bogus i-shop sites or even the sophisticated Internet systems where the user is attracted to sign-up for some service or membership. The hackers may even represent statements falsely guaranteeing security such as a digital certificate or SSL-encryption on their site. Having no idea of what is going on the unsuspecting user can easily compromise his identity, credit card or social security number. The input forms ask for all this data and more. The worst thing about it is that the user may be the last to know about the unpleasant results from his personal data security breach.

As a result from these considerations, any secret data may be intercepted and decrypted unless they pass through the communications network just once.

### BRIEF SUMMARY OF THE INVENTION

The object of the present invention is a method of the disposable command passwords that offers secure user's access to the information system resources. Its substance consists in alteration of an encoded object from a system user to his directive to the information system. Therein after, the terms “directive” and “command” are used interchangeably. The user's directive is a query to an information system database in order to make its modification. Each directive to the information system is encoded by a disposable command password (DCP). The disposable passwords are generated in a random way so as there are not two the same passwords. The process of a directive encoding in the information system comprises a disposable passwords' issuance and juxtaposing each unique password with the one of the system-allowed command. After then, the disposable command password is handed out to the authorized holder who may once only instantaneously run the command in the information system in accordance with this password. The password is blocked up by the system immediately afterwards so that its re-use becomes impossible. Password blocking means its status modification in the information system database by additional record that denotes the given password has been used or become invalid.

Information system consists of integrated hardware and software intended for data gathering, storage and processing. As currently implemented, the information system proofing is based on the user login identification by means of a username and password. For the users' record keeping the information system establishes and operates the users' log, password list and assigns the certain permissions to each user. To execute any directive in the information system its user logs in by entering his username and password. Then this data is transmitted through the communications network being encrypted by some relevant technique. If the password is accepted the user is able to execute many directives in the information system according to his permissions during some extended period of working session. If the username and password are lost or stolen a lot of destructive impact upon the information system can be done on his behalf. Therefore, the username and password require substantial protection that results in high expenses for data encryption and other security measures.

As distinct from the existing approach to information systems' security, the invented method encodes not the user but his commands toward the information system. Advantageously, this means total user anonymity and defeats an identity theft. Also, there is no need to encrypt a disposable command password in order to transmit it through the open communications network because it turns invalid immediately after its first once only instant utilization. Thereby, any violation of the password holder authority for the system-permitted command is excluded.

In response to the user's query the information system requests the relevant disposable command password to be entered. If the submitted password is valid, the information system blocks up the password immediately upon its acceptance, and then the information system executes the password-related directive. Main functional principle of such an information system is that the user may effect it only once and only by the command corresponding to his or her disposable password. In that way, the same password re-entry is ineffective.

Another essential advantage of the present invention is that the disposable command passwords are not encrypted to be transmitted via the communications network. It does not degrade the system security because the information system blocks up the disposable password immediately upon its input. In any case, the information system security is a matter of safe distribution of the disposable passwords among the system's users. This task is much easier than protection of all open communications network's channels such as the Internet and Internet-like networks, phone lines in general use, all types of wireless radio communications and other links that are used for data transfer and where the data traffic can be easily intercepted. Of course, the users must follow non-disclosure measures for unused DCP but this already requires neither complicated encryption techniques nor protected data transfer communications. Avoidance of the open channels for distribution of the DCP among the users makes the information system with disposable command encoding intrinsically secure on logical level.

The invention can be used in many areas such as the transaction processing systems in the communications network including the Internet, telephone and wireless, and, particularly, in the electronic payments of all kinds. Also, the invention is useful wherever the user's authenticity is required in order to get access to any personal, commercial or other secret information. For instance, it takes place in online banking systems, credit bureaus, government institutions, medical record databases.

### BRIEF DESCRIPTION OF THE DRAWINGS

Further objects, features and advantages of the invention will become apparent from the following detailed description taken in conjunction with the accompanying figures showing illustrative embodiments of the invention, in which:

FIG. 1 is a diagram illustrating a process of the information system operations using the disposable command encoding (DCE) in accordance with the invention;

FIG. 2 is a diagram illustrating a process of the information system operations using the DCE featuring an user's control of the executed directives in accordance with the invention;

FIG. 3 is a functional scheme illustrating a process of the information system operations using the DCE for electronic payments in accordance with the invention;

FIG. 4a illustrates an information-carrying medium for the DCP distribution to the payment system users, therein after called “netnote”, in accordance with the invention;

FIG. 4b is a schematic of the back of the netnote illustrated in FIG. 4a;

FIG. 4c is a schematic of a netnote folding process;

FIG. 4d is a front elevation of the folded netnote;

FIG. 5 is a flowchart illustrating a payment process using the DCE in accordance with the invention;

FIG. 6 is a flowchart illustrating a process for money transfer using the DCE in accordance with the invention.

Throughout the figures, unless otherwise stated, the same reference numerals and characters are used to denote like features, elements, components, or portions of the illustrated embodiments. Moreover, while the subject invention will now be described in detail with reference to the figures and in connection with the illustrative embodiments, changes and modifications can be made to the described embodiments without departing from the true scope and spirit of the subject invention as defined by the appended claims.

### DETAILED DESCRIPTION OF THE INVENTION

It is presumed that any open communications network is insecure so as any data traffic going through it can be intercepted and divulged. In accordance with the present invention a method for secure user's access to the information systems is offered. The invented method comprises an encoding of each system-allowed user's command by a disposable password and passwords' distribution or selling among the system users. The information system user is allowed to carry out only the directives that correspond to the disposable command passwords (DCP) that he owns.

If the user's DCP is accepted valid, the information system instantly blocks up the DCP so that it is impossible to re-use it and runs the relevant command in response. Password blocking is a modification of the information system database by additional record that denotes the given password has been used or become invalid. The user has not to be identified to get access to the information system. His authenticity and authority to run the command is recognized as long as he inputs the valid DCP.

The method of the present invention has several advantages over the prior art methods for information system security protection. First, security protection becomes intrinsic to the information system property. The information system is secure not because of encryption, as currently implemented, but because of a logic of its inner structure and the principle of operations. Second, nobody gets the user's personal data, just a password (DCP). Therefore, it is impossible to misuse the user's personal data for fraudulent purposes. There is no even theoretical thread of the identity theft. Third, because of the principle of operations of the information systems built on the invented method the user benefits by usability features comprising convenience, simplicity of use and mobility. Convenience results in that there is no need to remember username and password, sign in or fill in forms on a information system site. The transaction is processed in real-time, including the results viewing. Simplicity of use means that the user does not have to install any additional software on his or her personal computer. No special skills or knowledge required. Mobility is provided by the system's both hardware and software independence. The user's terminal location does not matter so the user's commands can be run from anywhere. Fourth, the information system openness enables the user to control an execution of his directives in real-time so there is no risk to discover something wrong when it is too late.

The invented method is valuable to businesses, too. The information system for business operations built on the DCE method is more efficient as compared with the current mode of security protection because it does not require costs on encryption and the communications network protection, and, hence, high-paid personnel involved. Since the directives are executed in real-time, the method of the DCE potentially reduces time-per-order and increases overall business productivity.

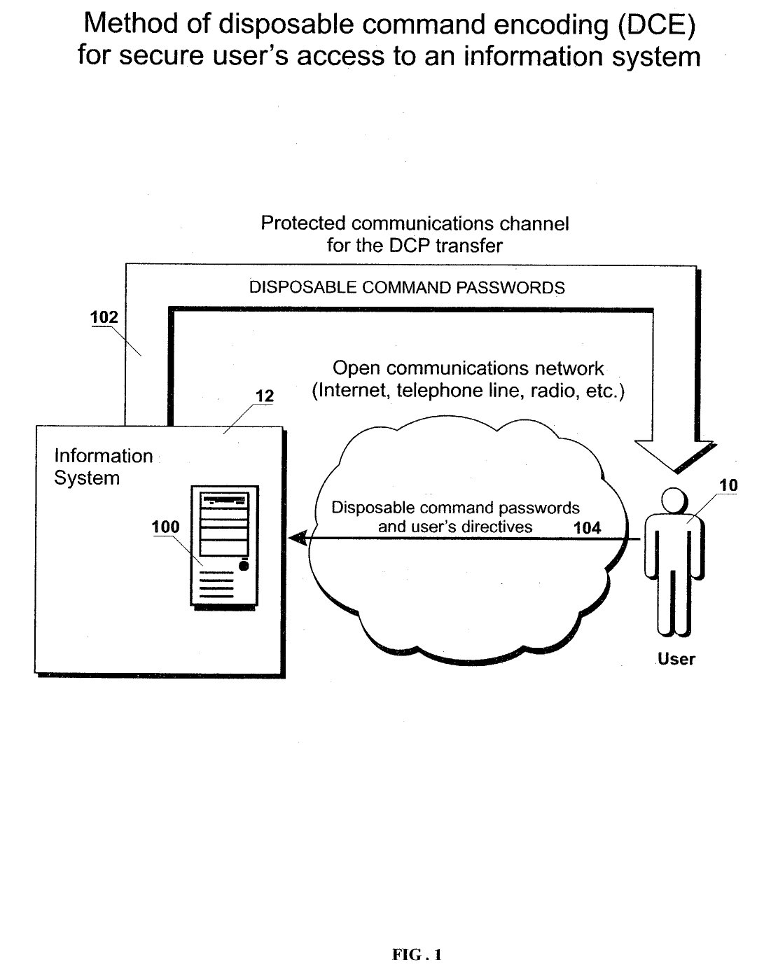

The method is described in more detail with reference to the figures. A method of the DCE is illustrated in FIG. 1, includes system user 10, information system 12 that the user refers to. In step 100 the system server generates the disposable command passwords (DCP) and correlates each of them with the executable directive. Then the passwords and the list of the directives are transferred to the user 102 by some protected communications channel. For example, this data can be handed out to user at a POS location. When the user wants to run a certain command in the information system, he enters the directive and relevant DCP 104. If the DCP is accepted, the system blocks up the DCP and runs its corresponding command. If the entered DCP is invalid or already used, the system rejects the command. In this simple and reliable way, the re-use of the same DCP is impossible.

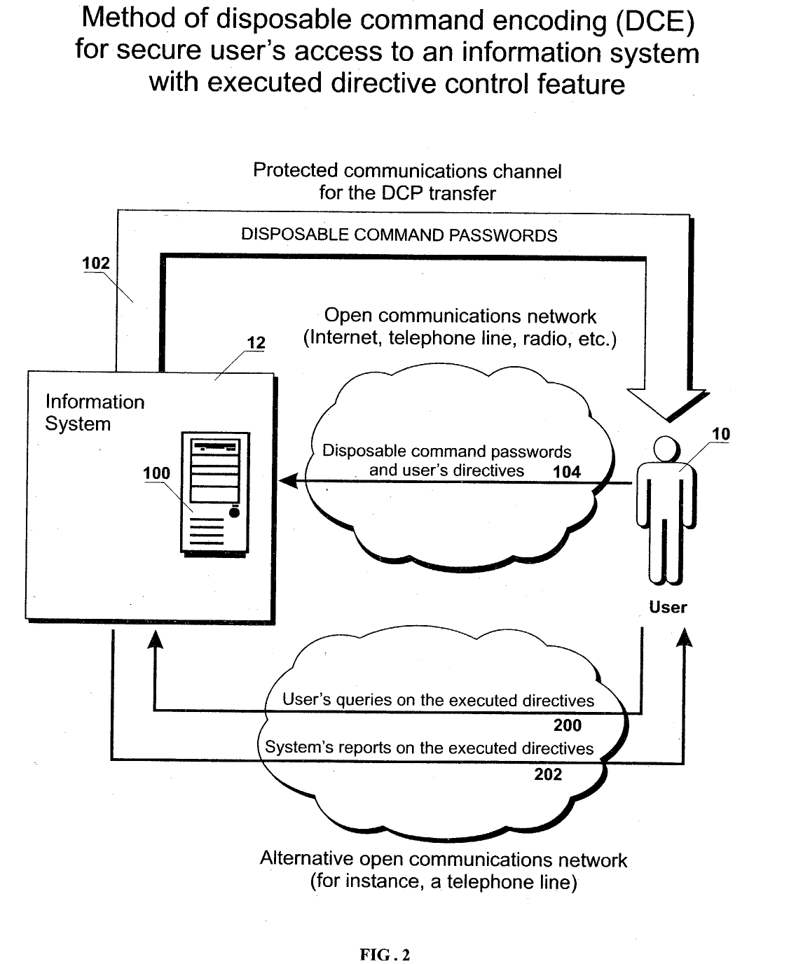

As it has been assumed, the open communications network is insecure so that a criminal can intercept traffic. For example, he can substitute the information system and spoof the user. Thus, the criminal can obtain the DCP from the user and then use it for prejudicial actions. Now it happens when criminal creates a phoney web site that sells some goods or services and proposes the user to enter his credit card information. In FIG. 2, to avoid spoofing the user 10 can view the results from his commands in real-time mode. In step 200 the user sends a query to the system on the executed directives he has given. In response the system submits the report 202 on the directives it has executed. If this report is incorrect the user instantly discovers the criminal activity and may react immediately. This control feature reinforces security and prevents spoofing.

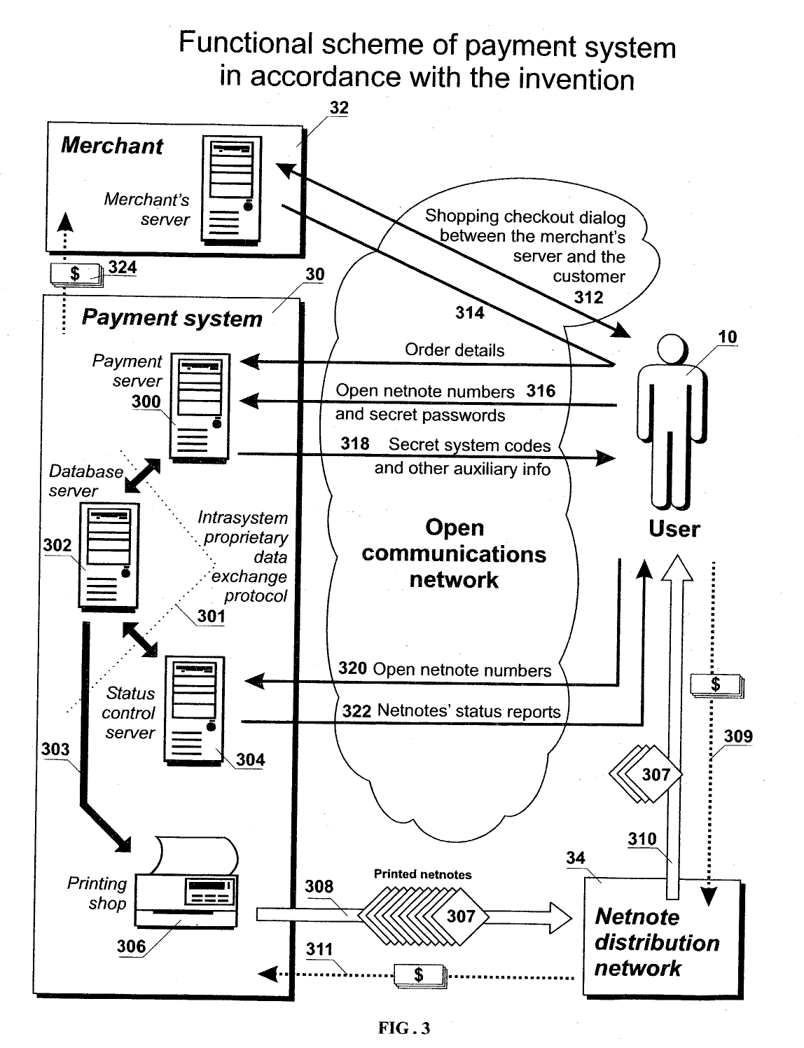

The present method can be applied to various information systems wherever the restricted access is essential for proper system operations. The DCE is especially valuable in applications related to electronic financial transactions. Recent drastic growth of electronic commerce and the Internet transactions particularly, demands for adequate progress in online payment processing solutions. The functional scheme of electronic payment system shown in FIG. 3 includes a payment system 30, user 10, merchant 32 and a network for the DCP distribution 34. The payment system 30 consists of payment server 300, database server 302, status control server 304 and printing shop 306. The payment system servers communicate by an intrasystem proprietary data exchange protocol 301 that thwarts possible hacker's attempts to crack the database server. This is a proprietary hardware and software solution designed for communication of the servers. To avoid the possibility of the information system spoofing or its illegal substitution the user enters the DCP only in response to the correct system replies or codes. If the system authenticity or confirmation code transmitted by the system does not match up with that the user has at hand he simply interrupts the transaction immediately. Therefore, the disposable command password is not compromised unless the user is assured about the system's server authenticity. In accordance with the application, the disposable command passwords are represented by two codes—User Authenticity Code (UAC) and User Confirmation Code (UCC), and System Authenticity Code (SAC) and System Confirmation Code (SCC) represent the system replies. According to an embodiment of the invention, for distribution of the authenticity and confirmation codes to the users a medium 307 named “netnote” is used. Each netnote 307 is a small piece of paper folded and sealed so that it is impossible to read anything inside unless it is torn open. The database server 302 generates the codes and netnote numbers in a random way. The netnotes are produced 303 in printing shop 306 and then handed over 308 to a point of sale (POS) network 34. In step 310 the user 10 purchases the netnotes at a POS such as a bank branch, super market or other retail establishment of a designated POS agent. Alternatively, other techniques in distribution of disposable passwords such as the scratch cards or electronic data-carrying medium may be applied.

The database server 302 keeps the netnote file that consists of the netnotes records. Each netnote record comprises its number, SAC, UAC, SCC, UCC, denomination (monetary value), current balance, a netnote status (i.e. “sold”), date of last status modification and payment order identifier. The netnote is ready-to-use once the payment system obtains a report from the POS agent transmitted via the communications network that confirms its selling 311. By that moment the netnote has no value. Therefore, if a netnote is lost or stolen while being shipped to the POS agent its unauthorized use is impossible.

To make an online purchase the user goes to the merchant's site 32, selects items in the shopping cart and chooses the netnote payment system 312 through the Web page there. The order summary is generated by the merchant software, totaled and redirected 314 to the payment server 300 by the HTML-instructions on the merchant's Web page for payment information input. The steps 316 and 318 denote the user communications with the payment server 300 as it described in detail below. The user 10 enters by keyboard or keypad as many netnote numbers as it takes to cover the entire invoice amount. The numbers are entered one by one. The payment server 300 validates the numbers by its software and determines if the amount is sufficient to cover the entire invoice amount. Next the server 300 asks the user through the Web page for a new netnote number to assign any over payment amount, if any. This new netnote is also validated the same way. Then the server 300 opens the authenticity codes input Web page. If the order total was equal to the netnote numbers balance the user gets directly to this page. The system warns the user through the Web page that the payment process is going into the final stage. The user is now allowed to tear open the appropriate netnotes. He must compare a SAC 406 for each netnote with those printed on the relevant netnote and input a UAC 407 through the Web page in response. In the case of any discrepancy between the code received from the payment server and that of printed in his netnote, the user must interrupt any data input and operations with his computer and contact the technical support service immediately. If the system server recognized the UAC 407 by its software, then it freezes the respective netnote numbers as designated for this particular transaction or payment order, thereby excludes their utilization for any other transaction. Next the system submits its SCC 408 and requests the user to compare them with those of printed on his netnotes. If they match up, the user enters his UCC 409. If the user confirmation codes are accepted valid, the payment system informs him that the payment is successfully completed. In addition, the system reminds the user that for security reasons he must log in to the Netnote® status control server 304 by entering its Web-address in new browser window and audit the payment details 322, particularly the delivery address by entering the number of any netnote used to pay the order 320. Moreover, the user must check out the current balance of the netnote number for the overpaid balance refund 322. In order to prevent the right data fitting, the system suspends the payment by its software if the user made more than three mistakes at the time of any data entry. In that case, he is prompted to try again later.

The process of payment is performed in real-time. Only the steps 311 and 324 involving settlement do not have to be performed in real-time and are preferably performed only about once a day. In step 311 the distribution agent 34 transmits over the communications network to the payment server a list of netnote numbers sold and settles with the payment system 30, which in turn transmits to the merchants the list of the paid orders and settles with the merchant 32.

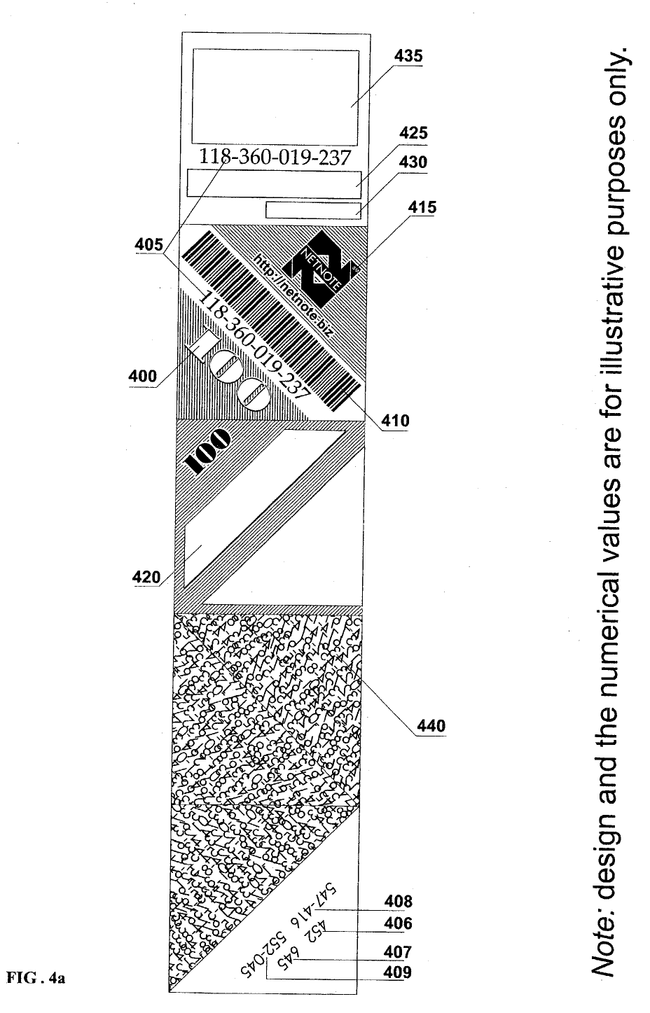

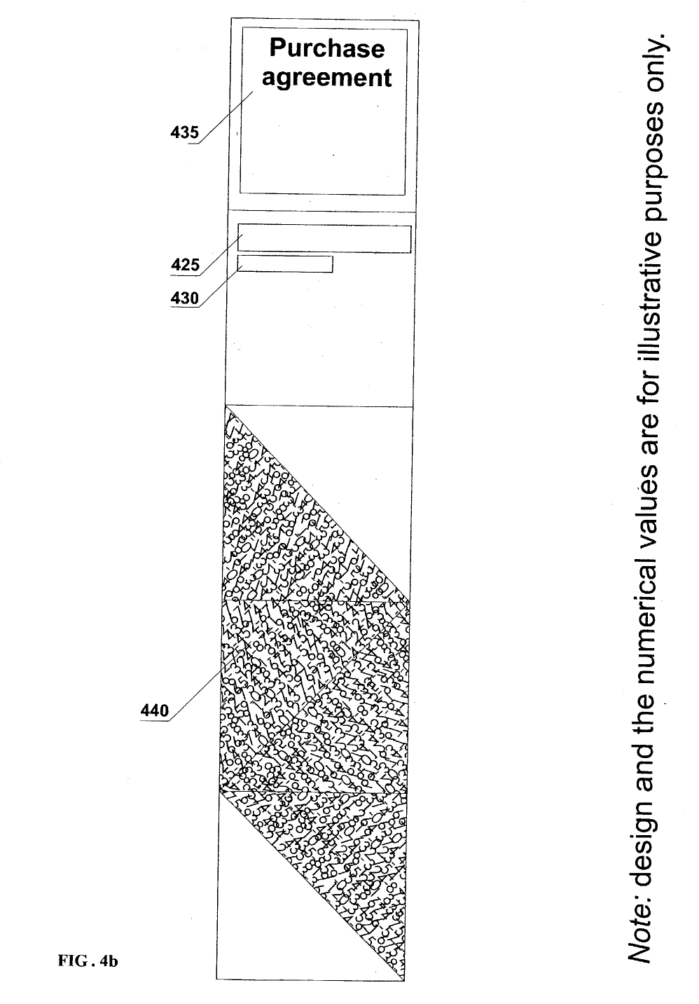

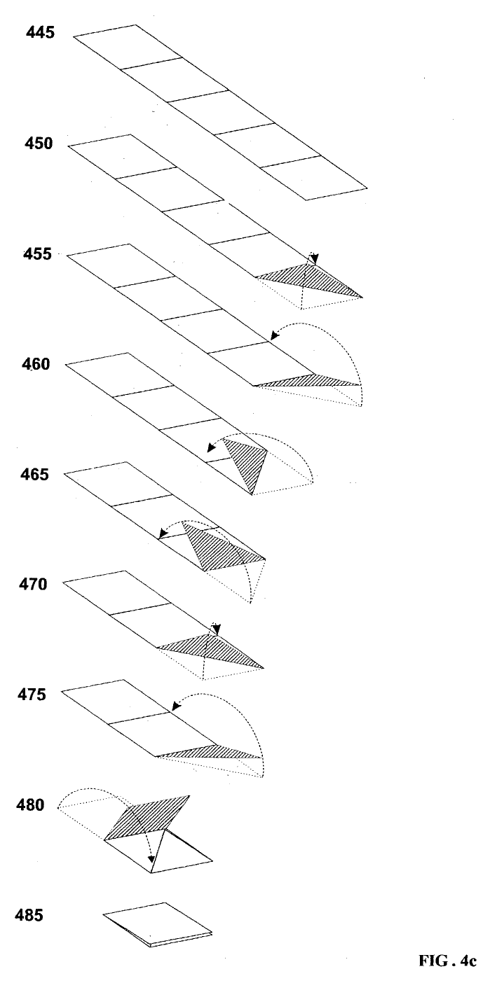

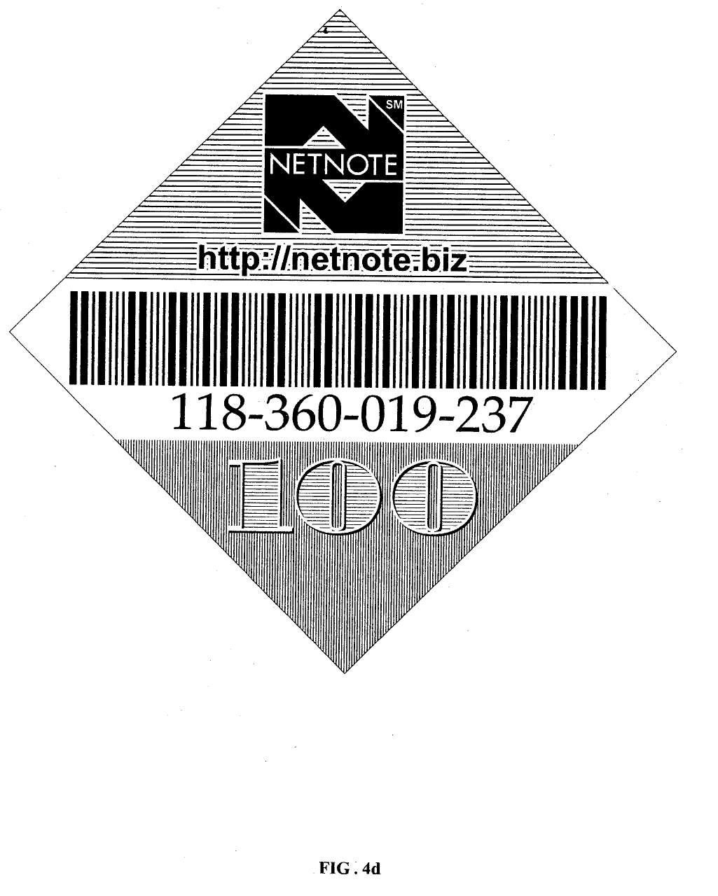

Design of an unfolded netnote as it comes out the printer is depicted in FIG. 4a and 4b. One side of the netnote in FIG. 4a has a face monetary value 400 in dollars or other currency, serial number 405, SAC 406, UAC 407, SCC 408, UCC 409, bar code 410 used for manufacturing inspections, the logo 415 of financial services (e.g. Netnote®) accessed by the netnote. Also, the netnote has some additional information 420. The other side in FIG. 4a has fields for user's signature 425 and date 430 that are filled by the user at the POS when he or she purchases the netnote. Each netnote has a tear-off purchase agreement 435 between the payment service provider and the user that has to be signed and dated at the POS, too. The agreement 435 with the netnote number 405, user's signature 425 and date 430 is then torn off and kept in file at a POS or in the payment service provider archive in case of any potential dispute in the future. There are the background noise margins 440 on both sides of the netnote for the code visual proof.

After printing the netnotes are folded and sealed as illustrated in FIG. 4c. When the netnote is folded as it shown in fragment 485 the background margins 440 on both sides of the netnote provide dense visual noise for the codes 406, 407, 408, 409 printed inside to make them impossible to read from outside. The front elevation of the netnote is shown in FIG. 4d. It is noteworthy that netnote can have denomination assigned and printed outside it at the POS terminal. In this case the database server 302 assigns the denomination by its software according to the POS report for this particular netnote number 405.

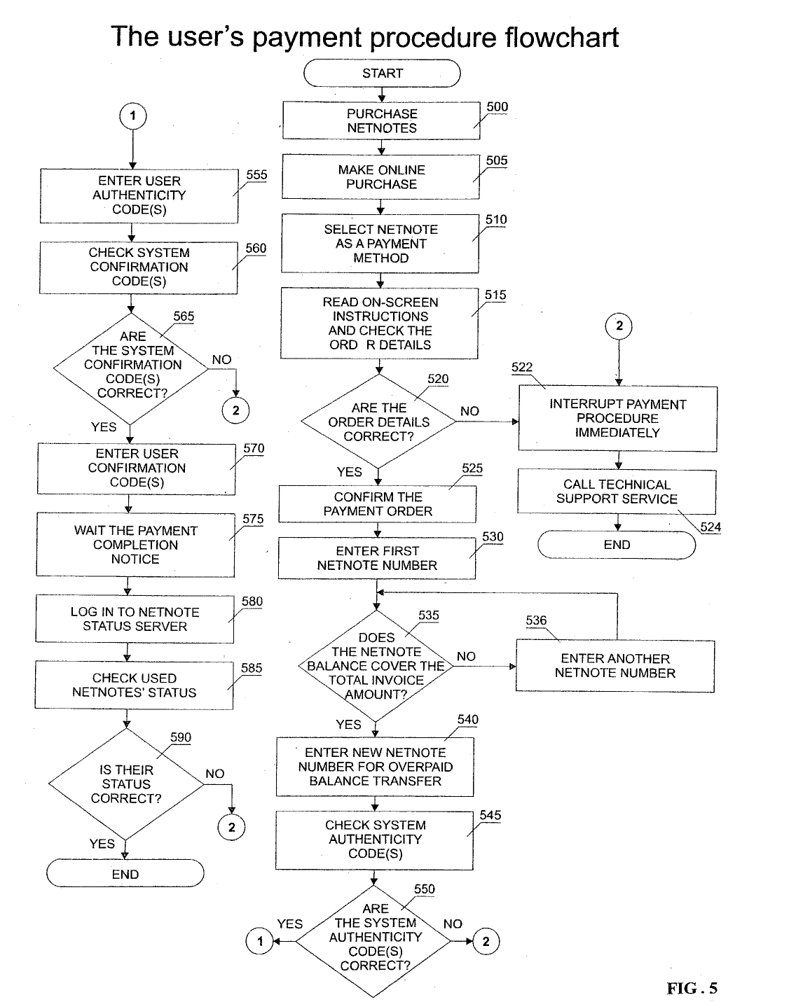

The process of electronic payment from user's side in accordance with the application is illustrated in the flowchart in FIG. 5. In step 500, user 10 purchases the netnotes 307 by providing payment in cash, check, credit or debit form to agent 34 who operates an establishment in which a POS located. In step 505, user 10 makes online purchase on merchant site 32 and goes to checkout Web page. There the user 10 chooses netnote payment system in step 510 and then he is automatically redirected to the payment server 300. On the payment server 300 the user has to read on-screen instructions and check his purchase order details in step 515. If the order details are accurate the user confirms his directive to pay for it 525 and then enters one netnote number 405 that he wants to use 530 through the relevant Web page. The payment server 300 inquires a database server 302 via intrasystem communications on a balance available for this given netnote number 405. If this amount is less than that of the order, the user enters another netnote number 536 until the total balance of the numbers entered exceeds or equal to the invoice amount. In step 540, user enters new netnote number that he wants to assign the over payment amount. In step 545, user must check the system authenticity codes with those printed in his netnotes 406. User tear opens the netnotes and if the SAC match up, he or she enters the user authenticity codes 407 in step 555. The database server validates the UAC and freezes the respective netnote numbers 405 if the codes are accepted by its software. In the same manner the user compares the system confirmation codes 408 in step 560 and if they match with those printed on the netnotes, in step 570 he enters the user confirmation codes 409. After that user has to make sure of successful payment completion in step 575. In step 580, user logs in the netnote status control server 304 by entering the Internet address printed outside 420 the netnote in his Internet browser window and in order to check the transaction results 585 enters any of used netnote numbers 405. This feature protects user from spoofing. If in the steps 520, 535, 550, 565, 590 some data appears incorrect, the user must interrupt payment and operations with his computer immediately 522 and inform the technical support service 524.

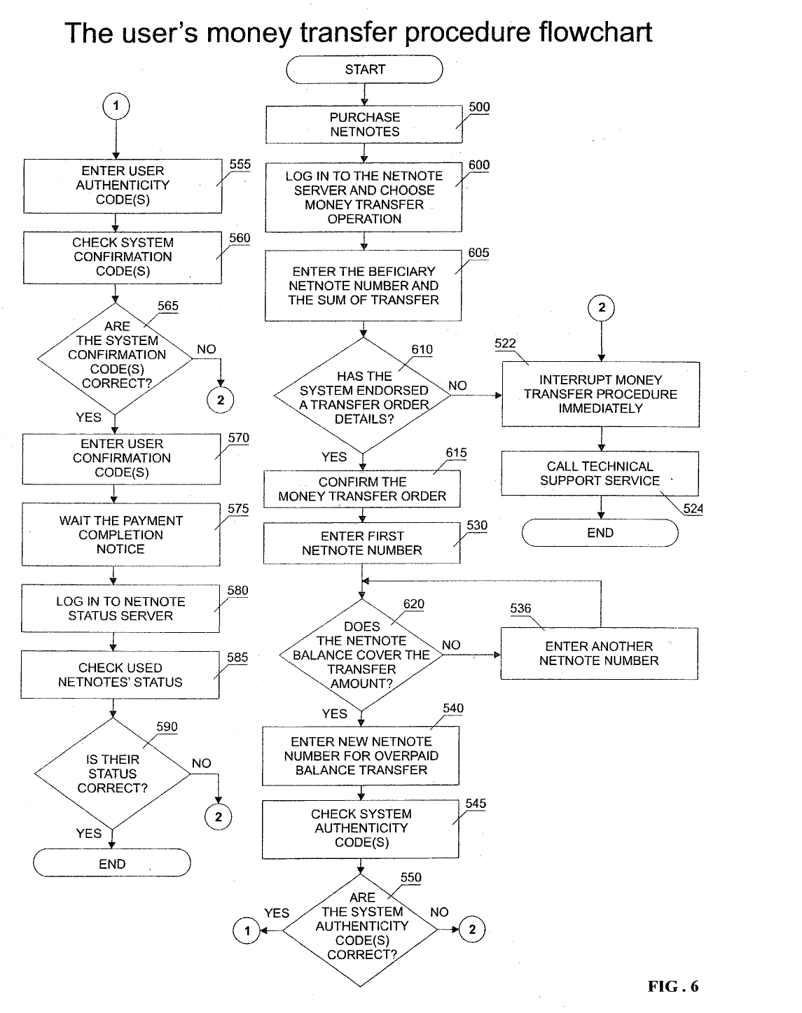

In another application, the netnote is used for a money transfer between the payment system users. Recipient informs sender beforehand about the netnote number or numbers 405 he wants to be credited and the sum of transfer. As illustrated in FIG. 6 in step 600, the sender logs in the payment server 300 and chooses money transfer operation on its relevant Web page. In step 605 sender enters the recipient's netnote number 405 and the sum of transfer. If the payment system endorsed the transfer amount and destination netnote number 405, the sender confirms the money transfer order 615. In steps 620, sender views the balance for the netnote number entered and adds another one 536 in the same manner as he would do in payment procedure. The other steps of money transfer process are the same to those of the payment procedure. Alternatively, money can be transferred if the sender hands his netnotes over recipient in person.

The user can obtain refund for any unused netnote by its presentation at the POS terminal along with a proof of purchase, e. g. cashier receipt. In this case the user's identification may be required.

Although the present invention has been described with reference to certain preferred embodiment, various modifications, alterations and substitutions will be known or obvious to those skilled in the art without departing from the spirit and scope of the invention, as defined by the appended claims.

We claim:

1. A method for security protection in the information systems that provide a user with secure and anonymous access to its resources over communications networks without any data encryption, comprising the steps of:
encoding of system-allowed commands by disposable passwords produced by a random-number generator built in the information system so as there are no two same passwords;
storing generated passwords into the information system database for their further utilization;
issuing and distributing generated and stored disposable command passwords to information system users through the protected communications channel;
for secure access to the information system resources through any insecure communications network, the user justifies the user's authority to run the certain commands by entering their corresponding disposable passwords;
if the disposable command password entered by the user matches with that stored in the system database and is marked as unused earlier, then the information system marks it up as used and executes the relevant user's command;
if the disposable command password entered by user does not match that stored in the system database or is marked as already used, then the information system rejects the user's command.

2. The method of claim 1 wherein a user carries out a transaction over the communications network, comprising the steps of:
purchasing a transaction record, comprising a number, a user authenticity code, a user confirmation code, a system authenticity code, and a system confirmation code;
making an online purchase;
employing said transaction record as a payment procedure;
determining if the order detail are correct and interrupting the payment procedure if they are not correct;
if the order details are correct confirm the payment order;
enter the correct number of transaction records to pay for the purchase;
check the system authenticity codes;
if the system authenticity codes are not correct, interrupt the payment procedure;
if the system authenticity codes are correct, enter the user authenticity codes, since at that moment the transaction records employed for said transaction are impossible to use for any other transaction because they are referred to said particular transaction in the information system database server;
check the system confirmation codes;
if the system confirmation codes are not correct, interrupt the payment procedure;
if the system confirmation codes are correct, enter the user confirmation codes;
check the status of the used transaction record;
if the status is not correct, interrupt the payment procedure;
if the status is correct, terminate the transaction.

3. The method of claim 2, wherein a user carries out a money transfer over the communications network employing the purchased transaction records as a instrument of payment.

4. A method for security protection in information systems, having a data base, that provide a user with secure and anonymous access to its resources over communications networks without any data encryption, comprising the steps of:
providing a random-number generator for said information system;
encoding system-allowed commands by disposable passwords generated by said random-number generator such that each password is different;
storing said generated passwords into the information system database for their further utilization;
issuing and distributing said generated and stored disposable command passwords to information system users;
justifying the user's authority to run certain commands by entering the user's corresponding disposable password;
if the disposable command password entered by said user matches with that stored in the system database and is marked as unused earlier, having the information system marks it up as used and executing the relevant user's command;
if the disposable command password entered by user does not match that stored in the system database, having the information system reject the user's command;
if the disposable password entered by the user is marked as already used, having the information system reject the user's command.
